(19) United States
(12) Patent Application Publication
(10) Pub. No.: US 2026/0268223 A1
(43) Pub. Date: Sep. 10, 2026

(54) SYSTEMS, METHODS AND NON-TRANSITORY COMPUTER-READABLE STORAGE MEDIUMS FOR MODULAR FEDERATED LEARNING

(71) Applicant: Nokia Solutions and Networks Oy, Espoo (FI)

(72) Inventors: Lorena QENDRO, Cambridge (GB); Chi Ian TANG, Cambridge (GB); Dimitrios SPATHIS, Cambridge (GB); Soumyajit CHATTERJEE, Cambridge (GB); Mohammad MALEKZADEH, Cambridge (GB)

(21) Appl. No.: 19/560,943

(22) Filed: Mar. 9, 2026

(30) Foreign Application Priority Data
Mar. 10, 2025 (FI) 20255200

(51) Int. Cl. G06N 20/00

(52) U.S. Cl. CPC G06N 20/00

(57) ABSTRACT

A method for performing federated learning includes obtaining an initial model at a server and receiving, at the server, resource capacity of a client. The resource capacity of the client corresponds to a model reduction ratio. The method further includes determining a modular model for the client based on the model reduction ratio, sending the modular model to the client for training the modular model at the client, and receiving, from the client, a locally trained model corresponding to the modular model. The locally trained model is trained with client data at the client. The method further includes updating the initial model based on the locally trained model and calculating a loss value for the initial model with a loss function.

### TECHNICAL FIELD

One or more example embodiments relate to methods, systems, and/or non-transitory computer-readable storage mediums for modular federated learning.

### BACKGROUND

Federated learning is a decentralized machine learning process that enables training of machine learning models across multiple devices and/or servers with data of the individual devices and/or servers. Federated learning maintains privacy of data as data from devices and/or servers is only used locally.

### SUMMARY

The scope of protection sought for various example embodiments is set out by the independent claims. The example embodiments and/or features, if any, described in this specification that do not fall under the scope of the independent claims are to be interpreted as examples useful for understanding various embodiments.

In at least one example embodiment a method for performing federated learning includes obtaining an initial model at a server and receiving, at the server, resource capacity of a client. The resource capacity of the client may correspond to a model reduction ratio. The method may also include determining a modular model for the client based on the model reduction ratio, sending the modular model to the client for training the modular model at the client, and receiving, from the client, a locally trained model corresponding to the modular model. The locally trained model may be trained with client data at the client. The method may further include updating the initial model based on the locally trained model and calculating a loss value for the initial model with a loss function.

In at least one example embodiment, the sending, the receiving the locally trained model, the updating, and the calculating may be repeated until the loss value is below a threshold.

In at least one example embodiment, the server may determine the model reduction ratio for the client based on the resource capacity of the client.

In at least one example embodiment, the updating the initial model may be further based on a weight of the client.

In at least one example embodiment, the model reduction ratio may be determined based on a total number of floating point operations of the client.

In at least one example embodiment, the initial model may be pretrained at the server with data stored on the server.

In at least one example embodiment, the modular model may include a depth and representation dimensionality representing an efficiency-accuracy trade-off.

In at least one example embodiment, the updating the initial model based on the locally trained model may include averaging the initial model with the locally trained model and a weighting parameter. In at least one example embodiment, the averaging the initial model with the locally trained model and the weighting parameter is based on a number of clients, the weighting parameter, and an objective function for the client. In at least one example embodiment, the weighting parameter may be based on a number of clients using a same portion of the model as the client.

In at least one example embodiment, the updating the initial model may result in a trained model and the method may further include performing inference with the trained model.

Also described herein is a server storing a global model configured to be trained with federated learning. The server may include at least one memory configured to store instructions and at least one processor configured to execute the instructions to cause the server to obtain an initial model and receive resource capacity of a client. The resource capacity of the client may correspond to a model reduction ratio. The server may be further configured to determine a modular model for the client based on the model reduction ratio, send the modular model to the client for training the modular model at the client, and receive, from the client, a locally trained model corresponding to the modular model. The locally trained model may be trained with client data at the client. The server may be further configured to update the initial model based on the locally trained model and calculate a loss value for the initial model with a loss function.

Also described herein is a server storing a global model configured to be trained with federated learning, wherein the server comprises: means for obtaining an initial model; means for receiving resource capacity of a client, the resource capacity of the client corresponding to a model reduction ratio; means for determining a modular model for the client based on the model reduction ratio; means for sending the modular model to the client for training the modular model at the client; means for receiving, from the client, a locally trained model corresponding to the modular model, the locally trained model being trained with client data at the client; means for updating the initial model based on the locally trained model; and means for calculating a loss value for the initial model with a loss function.

In at least one example embodiment, the server may be configured to repeat the sending, the receiving the locally trained model, the updating, and the calculating until the loss value is below a threshold.

In at least one example embodiment, the model reduction ratio may be determined for the client based on the resource capacity of the client.

In at least one example embodiment, the updating the initial model may be further based on a weight of the client.

In at least one example embodiment, the model reduction ratio may be determined based on a total number of floating point operations of the client.

In at least one example embodiment, the initial model may be pretrained at the server with data stored on the server.

In at least one example embodiment, the modular model may include a depth and representation dimensionality representing an efficiency-accuracy trade-off.

In at least one example embodiment, the updating the initial model based on the locally trained model may include averaging the initial model with the locally trained model and a weighting parameter. In at least one example embodiment, the averaging the initial model with the locally trained model and the weighting parameter is based on a number of clients, the weighting parameter, and an objective function for the client. In at least one example embodiment, the weighting parameter may be based on a number of clients using a same portion of the model as the client.

In at least one example embodiment, the updating the initial model may result in a trained model and the server may be further configured to perform inference with the trained model.

Also described herein is a non-transitory computer-readable storage medium storing computer-executable instruction that, when executed by the at least one processor of a system, may cause the system to perform a method for performing federated learning. The method for performing federated learning may include obtaining an initial model at a server and receiving, at the server, resource capacity of a client. The resource capacity of the client may correspond to a model reduction ratio. The method may also include determining a modular model for the client based on the model reduction ratio, sending the modular model to the client for training the modular model at the client, and receiving, from the client, a locally trained model corresponding to the modular model. The locally trained model may be trained with client data at the client. The method may further include updating the initial model based on the locally trained model and calculating a loss value for the initial model with a loss function.

At least one other example embodiment provides an apparatus for performing federated learning. The apparatus may be configured to obtain an initial model and receive resource capacity of a client. The resource capacity of the client may correspond to a model reduction ratio. The server may be further configured to determine a modular model for the client based on the model reduction ratio, send the modular model to the client for training the modular model at the client, and receive, from the client, a locally trained model corresponding to the modular model. The locally trained model may be trained with client data at the client. The server may be further configured to update the initial model based on the locally trained model and calculate a loss value for the initial model with a loss function.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates a system that may implement one or more methods according to example embodiments described herein.

FIG. 2 illustrates an example embodiment of a system for modular federated learning.

FIG. 3 is a flow chart illustrating a method according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of a function or system element, it should be understood that one or more example embodiments discussed herein may be performed by one or more processors (or processing circuitry) at the applicable device, apparatus, element, or system. For example, according to one or more example embodiments, at least one memory may store instructions that, when executed by one or more processors, cause the system, or the like, to perform the operations discussed herein.

As discussed herein, the term “mechanism,” in addition to its plain and ordinary meaning, may refer to methods, apparatuses and/or non-transitory computer readable storage mediums where applicable.

As discussed herein, the terminology “one or more” and “at least one” may be used interchangeably.

It will be appreciated that a number of example embodiments may be used in combination.

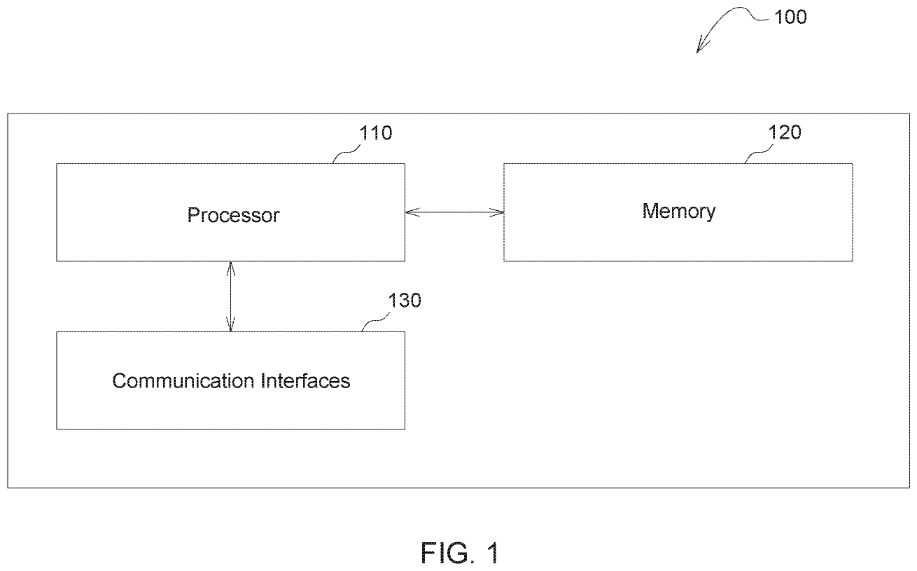

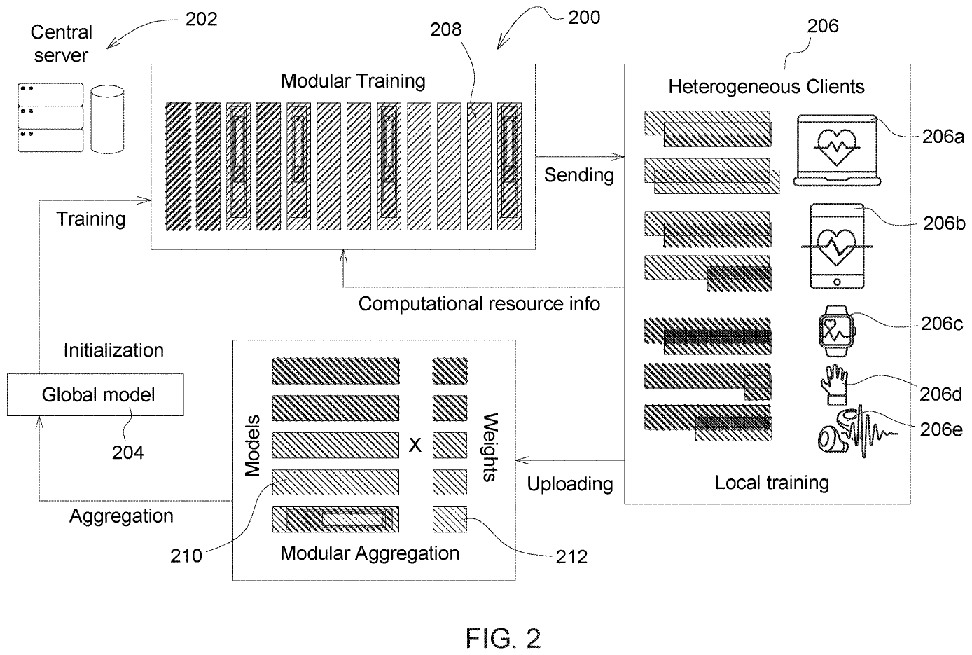

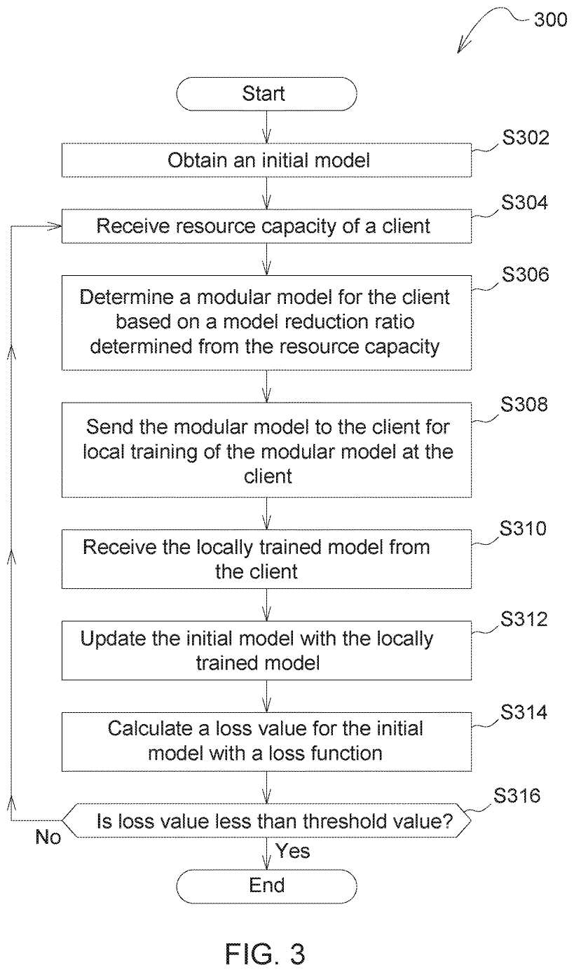

FIG. 1 illustrates an example embodiment of a system 100. The system 100 includes: a processor 110, a memory 120 connected to the processor 110, and various communication interfaces 130 connected to the processor 110. The various communication interfaces 130 may constitute a transceiver for transmitting/receiving data from/to other system elements. The system 100 may implement the systems and methods described herein in FIGS. 2-3.

As will be appreciated, depending on the implementation of the system 100, the system 100 may include many more components than those shown in FIG. 1. However, it is not necessary that all of these generally conventional components be shown in order to disclose the illustrative example embodiment. For example purposes, the example embodiment shown in FIG. 1 will be discussed with regard to the processor 110. However, it should be understood that the system 100 shown in FIG. 1 may include one or more processors or other processing circuitry, such as one or more Application Specific Integrated Circuits (ASICs).

The memory 120 may be a computer readable storage medium that generally includes a random access memory (RAM), read only memory (ROM), and/or a permanent mass storage device, such as a disk drive. The memory 120 may also store an operating system and any other routines/modules/applications for providing the functionalities of the system 100 to be executed by the processor 110. These software components may also be loaded from a separate computer readable storage medium into the memory 120 using a drive mechanism (not shown). Such separate computer readable storage medium may include a disc, tape, DVD/CD-ROM drive, memory card, or other like computer readable storage medium (not shown). In some example embodiments, software components may be loaded into the memory 120 via one of the various communication interfaces 130, rather than via a computer readable storage medium.

The processor 110 or other processing circuitry may be configured to carry out instructions of a computer program by performing the arithmetical, logical, and input/output operations of the system. Instructions may be provided to the processor 110 by the memory 120.

The various communication interfaces 130 may be wired and may include components that interface the processor 110 with the other input/output components. As will be understood, the various communication interfaces 130 and programs stored in the memory 120 to set forth the special purpose functionalities of the system 100 will vary depending on the implementation of the network node.

The various communication interfaces 130 may also include one or more user input devices (e.g., a keyboard, a keypad, a mouse, or the like) and user output devices (e.g., a display, a speaker, or the like).

FIG. 2 illustrates an example embodiment of a system 200 for modular federated learning. The system 200 may be configured to incorporate training on a wide variety of data on a model while maintaining privacy of the data used to train the model. In particular, for example, a model or a portion of the model may be sent from a server to at least one of a plurality of clients that each include local data. The model or portion of the model sent to a client may be referred to herein as a modular model. The model or the portion of the model may be locally trained and sent back to the server for incorporation back into the model. Thus, the model may be updated based (e.g., at least partially) on training performed locally without the data of the clients having to be shared outside of the local client. Maintaining local data at a local client may ensure compliance with privacy laws and restrictions and may also reduce risks of data breaches while still resulting in a model trained with a variety of data. Thus, the model may be relatively accurate and/or robust to a variety of data inputs when the model is deployed. Further, training a model in a modular way may accommodate a variety of clients and may improve communication efficiency because a portion of the model used for training at a particular device may be optimized for that particular device. The system 200 and methods described herein may balance data privacy, computational efficiency, and/or scalability in a federated learning environment.

Referring to FIG. 2, the system 200 includes a central server 202 storing a global model 204. In at least one example embodiment, the central server 202 may be implemented by the system 100 shown in FIG. 1. The global model 204 may be a machine learning model that may be trained via federated learning. In at least one example embodiment, the central server 202 may initialize the global model 204 with an estimated memory and computational requirement. In at least one example embodiment, the global model 204 may be untrained. Alternatively or additionally, the global model 204 may be pretrained at the central server 202 with data stored at the central server 202.

The system 200 also includes a plurality of clients 206. The plurality of clients 206 may be clients that are communicatively coupled with the central server 202. The plurality of clients 206 may include a first client 206a, a second client 206b, a third client 206c, a fourth client 206d, and a fifth client 206e. Although five clients are shown in FIG. 2, example embodiments should not be limited to this example. Moreover, according to one or more example embodiments, modular models may be sent to and/or trained models may be received from each or one or more of the plurality clients for training the global model 204.

Each of the plurality of clients 206 may include at least one of a computer, a smartphone, a smart watch, a smart ring, smart ear pods, and/or other clients that may be configured to collect, process, and/or analyze data. Each of the plurality of clients 206 may have a resource capacity. In at least one example embodiment, the resource capacity of each of the plurality of clients 206 may be a total number of floating point operations (“FLOPs”) of the client. Each of the plurality of clients 206 may be configured to communicate with the central server 202 to send its resource capacity to the central server 202 via its total number of FLOPs.

The central server 202 receives the resource capacity of each of the plurality of clients 206 and determines a model reduction ratio for each of the plurality of clients 206. In at least one example embodiment, the model reduction ratio is determined based on the total number of FLOPs of the client. For example, the global model 204 may require a total number of FLOPs to be executed. The model reduction ratio may be determined based on the total number of FLOPs needed to execute the global model and the number of FLOPs of the client of the plurality of clients. Thus, the model reduction ratios may be used to scale the global model 204 based on the computational capacity of each of the plurality of clients 206 determined by the FLOPs for each of the plurality of clients 206. In at least one example embodiment, additional parameters of each of the plurality of clients 206 may be used to determine the model reduction ratios. In particular, parameters such as memory constraints, inference latency, energy or power consumption, network bandwidth, training speed, task-specific accuracy needs, and/or historical performance metrics may be used to determine the model reduction ratio for each of the plurality of clients 206. Utilizing these additional parameters may ensure that the model reduction ratio is configured to adapt the global model 204 to clients' diverse resource limitations and task demands which may provide flexibility and efficiency in various federated learning scenarios. The central server 202 may store each of the model reduction ratios in association with each of the plurality of clients 206. For example, the central server 202 may store the model reduction ratios associated with each of the plurality of modular models 208 in the memory 120.

In at least one example embodiment, the central server 202 may be configured to determine a modular model 208 in response to each of the model reduction ratios. Each modular model 208 may be determined from the global model 204. In at least one example embodiment, the central server 202 may be configured to reduce the global model 204 in response to each model reduction ratio to determine the modular model 208 to send to a corresponding client of the plurality of clients 206. For example, if a model reduction ratio for the first client 206a is 10%, then the global model 204 may be reduced to 10% to create a modular model of a sufficient size to be deployed at the first client 206a. If a model reduction ratio for the second client 206b is 20%, the global model 204 may be reduced to 20% to create a modular model of a sufficient size to be deployed at the second client 206b. The modular model that is reduced to 20% may include the modular model that is reduced to 10%. Further, the global model 204 may be reduced at two levels. A number of layers may be reduced and/or a representation size may be reduced. The internal structure of each of the layers may not be modified in this reduction. The global model 204 may be built with a modular design which may mean that the model includes a plurality of layers. If the number of layers is being reduced and a model reduction ratio of 50% is used, the global model 204 may be reduced so that only the first half of the layers are sent to the client. If a representation size is being reduced, rather than utilizing a full output from a layer, a smaller output may be used. For example, if a layer normally has a 2048-dimensional output, this output may be reduced to 512 dimensions so that the model may be configured for resource-constrained clients. Thus, reducing the global model 204 may not alter an internal structure of each layer of the plurality of layers of the global model 204. The internal structure may maintain the number of neurons in dense layers or filters in convolutional layers based on this reduction.

In at least one example embodiment, the global model 204 may include a plurality of nested layers. Each layer may have at least one dimension. In particular, the layers may include a depth and a representation dimension that may represent an efficiency-accuracy trade-off Each of the modular models 208 includes a plurality of layers of the global model 204 and has a last layer that is not equal to the last layer of the global model 204 unless the modular model 208 is equal to the global model 204. Each of the plurality of clients 206 is configured to train a respective modular model 208 to minimize a loss of the last layer of the modular model 208.

In at least one example embodiment, each of the plurality of clients 206 may train its respective modular model 208 locally. In at least one example embodiment, if the global model 204 is pretrained at the central server 202, the last layer of the global model 204 may be taken into consideration during the pretraining to ensure the global model 204 is optimized before generating the plurality of modular models 208 for training at the plurality of clients 206. The respective modular model 208 may be trained according to a training methodology defined by the federated learning system provider. Similarly, the global model 204 may be pretrained according to a training methodology defined by the federated learning system provider. The training may be one or more of fine-tuning, end-to-end training, or another technique based on the particular central server 202 and/or global model 204. Each of the plurality of clients 206 is attempting to perform risk minimization based on unique data of the client including training samples and corresponding labels. After training a modular model, each of the plurality of clients 206 may upload the locally trained modular model 210 to the central server 202.

In at least one example embodiment, the central server 202 is configured to incorporate each of the locally trained modular models 210 with the global model 204. In at least one example embodiment, each locally trained modular model 210 may be assigned a weight 212 and may be incorporated with the global model 204 based on the assigned weight 212.

For example, the assigned weight 212 may be a weighting factor or a weighting parameter that is used to compensate for the uneven training of different portions of the global model 204. In particular, most of the model reduction ratios will require the global model 204 to be reduced before being transmitted to the clients. Thus, a first portion of the global model 204 may be trained more frequently than a later portion of the global model 204. To account for the increased training of certain portions of the global model 204, the locally trained modular models 210 may be weighted before being incorporated with the global model 204. Portions of the global model 204 that are trained more frequently may be weighted higher than those that are trained less frequently.

Averaging of the global model 204 with the locally trained modular models 210 aims to optimize the function shown below in Equation [1].

$${min}_{w} f ( w ) = {\sum }_{i = 1}^{m} {α}_{i} ( {F}_{i} ( w ) := {E}_{{x}_{i} ∼ {D}_{i}} [ {f}_{i} ( w ; {x}_{i} ) ] ) \qquad [ 1 ]$$

In Equation [1], m represents the number of clients in the system, αᵢ is the weighting parameter for the i-th client, and Fᵢ(w) is the objective function for the i-th client, cᵢ. The weighting parameter, αᵢ, is defined as

$${α}_{i} = \frac{{n}_{i}}{{\sum }_{j = 1}^{m} {n}_{j}} ,$$

where nᵢ is the number of clients using the portion of the model that the i-th client is using.

In at least one example embodiment, after the global model 204 is updated with the locally trained modular models 210 a loss value is calculated. The modular models 208 may be representations that are of lower quality than the global model 204 because they may be reduced in size based on the model reduction ratios. Thus, a loss value may be determined to quantify an impact of utilizing the modular models 208 for training of the global model 204. The loss value may be determined with a loss function to determine an overall loss between the global model 204 before local training by the plurality of clients 206 and the global model 204 after being combined with the locally trained modular models 210. In particular, a goal of training the global model 204 via the modular models 208 at the plurality of clients 206 is to minimize both a loss of the last layer of the global model 204 and a last layer of each of the modular models 208. This minimization process enables optimization of the global model 204 and the modular models 208 at different levels of computational capacity across the plurality of clients 206.

In at least one example embodiment, the loss function may be given by Equation [2] shown below.

$$ℒ ( z ) = {\sum }_{d} ( ℒ ( {z}_{1 : d}^{L} ) + ℒ ( {z}_{1 : d}^{{l}_{d}} ) ) + {\sum }_{d} KL ( ℒ ( {z}_{1 : d}^{{l}_{d}} ) \vert \vert ℒ ( {z}_{1 : d}^{L} ) ) \qquad [ 2 ]$$

In Equation [2],

$${\sum }_{d} ( ℒ ( {z}_{1 : d}^{L} ) + ℒ ( {z}_{1 : d}^{{l}_{d}} ) )$$

is a sum of individual losses computed for each dimension of the last layer of the global model 204, L, and the last layer, 1, of each modular model 208. Also in Equation [2],

$${\sum }_{d} KL ( ℒ ( {z}_{1 : d}^{{l}_{d}} ) \vert \vert ℒ ( {z}_{1 : d}^{L} ) )$$

is a sum of Kullback-Leibler (KL) divergences for each dimension of the last layer of the global model 204, L, and the last layer, 1, of each modular model 208. A loss function may be determined based on a specific task or a goal of the federated learning framework. For example, a cross-entropy loss function may be used for a classification task while a different loss function may be used for tasks such as regression or segmentation. Thus, the losses may be determined specific to the federated learning framework in at least one example embodiment.

After calculation of the loss value, the central server 202 may compare the loss value to a threshold value. The threshold value may be a value indicating an acceptable overall loss signaling a completion of the training process. If the loss value is not less than or equal to the threshold value, then the system 200 may perform another iteration of training of the global model 204 as described above. The system 200 may perform iterations of training as described above until the loss value is equal to or below the threshold value. Alternatively or additionally, training of the global model 204 may end when a relative loss improvement is determined based on convergence, validation performance, or computational constraints.

Once the global model 204 is sufficiently trained, it may be deployed for inference at one or more of the central server 202 and/or the plurality of clients 206. Thus, the central server 202 and/or the plurality of clients 206 may utilize the global model 204 to complete an intended action such as performing a task, making a prediction, solving a problem, etc. Each client of the plurality of clients 206 may be configured to use its local data for inference of the global model 204. Similarly, the central server 202 may include data that can be used for inference of the global model 204. The central server 202 may not include data from the plurality of clients 206. Thus, inference may typically occur at the plurality of clients 206 rather than at the central server 202 itself.

FIG. 3 is a flow chart of a method 300 of performing federated learning according to example embodiments. For example purposes, the method 300 is described with reference to elements of the system 100 and the system 200 herein. However, example embodiments should not be limited to this example. In at least one example embodiment, the global model 204 may be trained at the central server 202 before any local training occurs. The method 300 is described with reference to a single client. However, example embodiments are not limited herein.

Referring to FIG. 3, at step S302 an initial model is obtained at a server. The initial model may be the global model 204 and the server may be the central server 202 described herein.

At step S304, the central server 202 receives a resource capacity from a client of the plurality of clients 206. As described above, the resource capacity of the client may be based on a total number of floating point operations (FLOPs) of the client.

At step S306, the central server 202 determines the modular model 208 for the client. The modular model 208 may be determined from the global model 204 based on the resource capacity of the client. In particular, as described above, the central server 202 may determine a model reduction ratio based on the resource capacity of the client. The model reduction ratio may be used to create a modular model specific to the client based on the client's resource capacity. Thus, training of the global model 204 may be optimized based on the client which may make training of the global model 204 more efficient.

At step S308, the central server 202 sends the modular model 208 to the client. The client may be configured to locally train the modular model 208 received from the central server 202. The modular model 208 may be trained at the client based on local data of the client. As described above, when the method 300 is performed on a plurality of clients, this process may maintain privacy of local data while allowing a variety of data to be used to train each of the modular models 208.

At step S310, the central server 202 receives the locally trained modular model 210 from the client.

At step S312, the central server 202 updates the global model 204 with the locally trained modular model 210. As described above, the locally trained modular model 210 may be weighted and may be averaged with the global model 204 to update the global model 204 with the locally trained modular model 210. In at least one example embodiment, the central server 202 may optionally perform fine tuning of the global model 204 using a small validation or auxiliary dataset to refine performance of the global model 204. Alternatively or additionally, the central server 204 may apply one or more regularization techniques to ensure consistency across updates from heterogeneous clients.

At step S314, the central server 202 calculates a loss value for the global model 204 with a loss function as described above.

At conditional step S316, the central server 202 determines whether the loss value is less than a threshold value. If the loss value is less than the threshold value, then the method 300 ends and the global model 204 is sufficiently trained. If the loss value is not less than the threshold value, then the method 300 returns to step S304 where training via the client of the plurality of clients 206 is repeated. This method 300 may continue with as many iterations as needed to achieve a loss value of the global model below the threshold value or to achieve a desired convergence criteria. In at least one example embodiment, the threshold value and/or the convergence criteria may be inputs that are stored at the central server 202.

In at least one example embodiment, after training of the global model 204 with the plurality of clients, inference of the global model 204 may be performed.

The method 300 may be expanded in at least one example embodiment to incorporate each client of the plurality of client 206. When a plurality of clients are used to perform local training of the modular models 208, each client may be individually in communication with the central server 202. Thus, each client may locally train a modular model and may communicate with the central server 202 independently of a remainder of the clients of the plurality of clients 206 and each iteration of the method 300 may be occurring simultaneously for the plurality of clients 208. In at least one example embodiment, training of the global model 204 may occur in rounds where each of the modular models 208 is sent to a corresponding client of the plurality of clients 206 and the global model 204 is not updated until the locally trained module models 210 are received back at the central server 202. This may ensure that the global model 204 reflects the contributions of each client of the plurality of clients 206 that received a modular model 208. In at least one example embodiment, asynchronous federated learning may occur which may cause the central server 202 to update the global model 204 with the locally trained modular models 210 as they are received from each client of the plurality of clients 206 and the training of the global model 204 may not occur in rounds where each locally trained modular model 210 is received prior to updating the global model 204.

The systems and methods described herein provide models that are trained with unique data from a plurality of sources while maintaining privacy considerations. The global model 204 may be relatively accurate and/or robust to a variety of data inputs when the global model 204 is deployed. Further, training the global model 204 in a modular way may accommodate a variety of clients and/or may improve communication efficiency. For example, a portion of the global model 204 used for training at a particular client may be optimized for that particular client. The systems and methods described herein may balance data privacy, computational efficiency, and/or scalability in a federated learning environment.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments are described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing servers or other system elements and/or hardware. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other client or clients capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, hardware, firmware, hardware executing software or any combination thereof may be used to implement the systems and methods described herein. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. A method of performing federated learning, the method comprising:
obtaining an initial model at a server;
receiving, at the server, resource capacity of a client, the resource capacity of the client corresponding to a model reduction ratio;
determining a modular model for the client based on the model reduction ratio;
sending the modular model to the client for training the modular model at the client;
receiving, from the client, a locally trained model corresponding to the modular model, the locally trained model being trained with client data at the client;
updating the initial model based on the locally trained model; and
calculating a loss value for the initial model with a loss function.

2. The method of claim 1, wherein the sending, the receiving the locally trained model, the updating, and the calculating are repeated until the loss value is below a threshold.

3. The method of claim 1, wherein the server determines the model reduction ratio for the client based on the resource capacity of the client.

4. The method of claim 1, wherein the updating the initial model is further based on a weight of the client.

5. The method of claim 1, wherein the model reduction ratio is determined based on a total number of floating point operations of the client.

6. The method of claim 1, wherein the initial model is pretrained at the server with data stored on the server.

7. The method of claim 1, wherein the modular model includes a depth and representation dimensionality representing an efficiency-accuracy trade-off.

8. The method of claim 1, wherein the updating the initial model based on the locally trained model includes averaging the initial model with the locally trained model and a weighting parameter.

9. The method of claim 8, wherein the averaging the initial model with the locally trained model and the weighting parameter is based on a number of clients, the weighting parameter, and an objective function for the client.

10. The method of claim 9, wherein the weighting parameter is based on a number of clients using a same portion of the model as the client.

11. The method of claim 1, wherein the updating the initial model results in a trained model and the method further comprises
performing inference with the trained model.

12. A server storing a global model configured to be trained with federated learning, the server comprising:
at least one memory configured to store instructions; and
at least one processor configured to execute the instructions to cause the server to obtain an initial model,
receive resource capacity of a client, the resource capacity of the client corresponding to a model reduction ratio,
determine a modular model for the client based on the model reduction ratio,
send the modular model to the client for training the modular model at the client,
receive, from the client, a locally trained model corresponding to the modular model, the locally trained model being trained with client data at the client,
update the initial model based on the locally trained model, and
calculate a loss value for the initial model with a loss function.

13. The server of claim 12, wherein the server is configured to repeat the sending, the receiving the locally trained model, the updating, and the calculating until the loss value is below a threshold.

14. The server of claim 12, wherein the model reduction ratio is determined for the client based on the resource capacity of the client.

15. The server of claim 12, wherein the updating the initial model is further based on a weight of the client.

16. The server of claim 12, wherein the model reduction ratio is determined based on a total number of floating point operations of the client.

17. The server of claim 12, wherein the initial model is pretrained at the server with data stored on the server.

18. The server of claim 12, wherein the modular model includes a depth and representation dimensionality representing an efficiency-accuracy trade-off.

19. The server of claim 12, wherein the updating the initial model based on the locally trained model includes averaging the initial model with the locally trained model and a weighting parameter.

20. The server of claim 19, wherein the averaging the initial model with the locally trained model and the weighting parameter is based on a number of clients, the weighting parameter, and an objective function for the client.

21. The server of claim 20, wherein the weighting parameter is based on a number of clients using a same portion of the model as the client.

22. The server of claim 12, wherein the updating the initial model results in a trained model and the server is further configured to perform inference with the trained model.
